(19) United States
(12) Patent Application Publication
(10) Pub. No.: US 2007/0202893 A1
(43) Pub. Date: Aug. 30, 2007

(54) Radio repeater

(75) Inventors: Adrian W. Payne, Horley (GB); Deborah L. Raynes, Basingstoke (GB); Richard J. Caldwell, Reigate (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,807

(22) PCT Filed: Mar. 1, 2005
(86) PCT No.: PCT/IB05/50741

§ 371 Date: Sep. 12, 2006

(30) Foreign Application Priority Data
Mar. 17, 2004 (GB) 0406091.9

(51) Int. Cl. H04J 15/00; H04Q 7/20

(52) U.S. Cl. 455/466; 370/464

(57) ABSTRACT

A radio repeater (8) operates in a radio communication system (1) (such as a Bluetooth® communication system) including a mobile telephone (2) and a personal digital assistant (PDA) (3) each having a (Bluetooth®) transceiver (5,6). The repeater (8) is housed in a headset (7) incorporating an earpiece and microphone (not shown) for voice communication. The repeater (8) comprises a receive antenna (9) for receiving signals, e.g. in a band around 2.4 GHz; means (12) for shifting the frequency of the received signals by a constant frequency interval, e.g. to a band around 800 MHz; and a transmit antenna (14) for transmitting the frequency shifted signals. So, the mobile telephone (2) and the PDA (3) can communicate with each other directly using their Blue-tooth® transceivers (5,6), but, if there is no signal propagation path between them, such as when the body of a user (4) comes between them, they can receive the signals transmitted by the repeater (8). As these signals have just been shifted in frequency, the transceivers (5,6), only need knowledge of the way in which the required signal was originally transmitted (e.g. its frequency hopping sequence) and the frequency shift to successfully receive the required signal via the repeater (8).

This invention relates to a radio repeater. More specifically, the invention relates to a radio repeater for use in a short range radio communication system and to a method of repeating a signal in a short range radio communication system.

Short range radio communication systems are becoming increasingly common. For example, many devices have now been developed that use short range radio transmission to communicate with one another in so-called “piconets”. Bluetooth® is an example of such technology and Bluetooth® enabled devices include mobile telephones and their peripheral devices, such as headsets and hands-free kits, as well as computers, personal digital assistants (PDAs) and such like. Similarly, the Institute of Electrical and Electronics Engineers (IEEE) has developed several standards for wireless networking, known generically as the 802.11™ Wireless Local Area Network (WLAN) standards and commercially as Wi-Fi®. At present, Wi-Fi® is most commonly used for communication between personal computers and a network, e.g. so-called “wireless networks”.

Typically, Bluetooth® devices have a range of around 10 m and Wi-Fi® devices have a range of around 100 m. However, these ranges may not always be achievable. For example, a body, such as the human body, may block a signal. This problem of signals being blocked is particularly acute outside, where reflected propagation paths may not be available and communication may rely entirely on a line of sight (LOS) path between communication devices. It can therefore be desirable to allow two devices that are unable to communicate directly, e.g. via a LOS path or a reflected path, to communicate via an intermediate communication device which is positioned to communicate with both communication devices separately. For example, when a device wishes to communicate with a distant device to which there is no usable signal propagation path, it establishes a communication link with the intermediate device. The intermediate device establishes a communication link with the distant device and relays signals between the two devices using the two communication links set up in the communication system. However, the applicants have recognised that the use of two such communication links is inefficient. For example, in Bluetooth® and Wi-Fi®, each separate communication link uses at least one channel. However, there are only a limited number of channels available in the given frequency band of a communication system. Using two channels to form a communications link that would normally be formed by a single channel therefore reduces the overall communication capacity of the system. More specifically, either fewer devices are able to operate in the system or less data can be sent.

The present invention seeks to overcome this problem.

According to a first aspect of the present invention, there is provided a radio repeater for use in a short range radio communication system, the repeater comprising a receiver for receiving a signal in a first frequency band and a transmitter for transmitting the signal in a second frequency band.

Also, according to a second aspect of the present invention, there is provided a method of repeating a radio signal in a short range radio communication system, the method comprising receiving a signal in a first frequency band and transmitting the signal in a second frequency band.

So, the repeater receives a transmitted signal in one frequency band and re-transmits it in another frequency band. This has the advantage that capacity of the communication system in the first frequency band is not affected by re-transmission of the signal. Overall communication capacity of the system in the first frequency band is therefore maintained.

The first frequency band may be that usually used in the communication system. For example, the signal may be transmitted by a first communication device and intended to be received by a second communication device in the first frequency band. However, where there is no useable signal propagation path between the first and second communication devices, the second communication device may receive the signal transmitted by the repeater instead of the signal transmitted by the first communication device.

So, according to a third aspect of the present invention, there is provided a short range radio communication system comprising:

a first communication device for transmitting the signal in the first frequency band;

the repeater described above; and

a second communication device for receiving the signal in the first frequency band or the second frequency band.

According to a fourth aspect of the present invention, there is provided a method of short range radio communication comprising:

transmitting the signal in the first frequency band;

repeating the radio signal using the method described above; and

receiving the signal in the first frequency band or the second frequency band.

The communication system is short range. Short range might mean a few metres, e.g. around 10 m, or as much as a few hundred metres, e.g. around 100 m. Typically, the communication system is suitable for implementing a wireless local area network (WLAN), which is a wireless network of communication devices operating in small area such as a building or office, or a body area network (BAN), which is a network formed by several devices worn or held near to a user's body. Specific examples of such communication systems include Bluetooth® or Wi-Fi® communication systems. So, the signal may be a short range signal, such as a Bluetooth® signal or a Wi-Fi® signal. Similarly, the first and second communication devices may be short range communication devices, such as Bluetooth® or Wi-Fi® communication devices.

As mentioned above, in short range communication systems such as these, the applicants have recognised that bodies, such as a human body of a user, can often block signals. In more detail, Bluetooth® and Wi-Fi® use a frequency band around 2.4 GHz. At this frequency, the human body attenuates radio signals by around 200 dB/m, although the amount of attenuation varies slightly depending on the part of the body through which the signal passes. This is enough to completely block a Bluetooth® or Wi-Fi® signal. So, communication devices used close to a user's body are often unable to communicate with one another. For example, it is quite likely that a mobile telephone in a user's back pocket will be unable to communicate with a PDA held in the user's hand using Bluetooth®.

It is therefore particularly preferred that the repeater is wearable. By wearable, what is meant is that the repeater may be worn on or attached to a user's body or clothing. Typically, the repeater can be positioned such that it is likely to be able to receive and transmit signals without the user's body blocking the signal. For example, the repeater may be wearable on a user's head. More specifically, the repeater may be incorporated in a headset, e.g. which includes an earpiece and microphone for voice communication. Thus, when the user's body blocks a signal, say between a mobile telephone in a user's back pocket and a PDA held in the user's hand, it is very likely that the repeater positioned on the user's head will still be able to receive and transmit signals to and from both the mobile telephone and the PDA.

As can be appreciated from the above, it is envisaged that the repeater can relay a signal between two devices when the signal propagation path between them is blocked inadvertently. So, the devices are usually well within range of each other. In other words, the devices are usually close enough together that, if not for all possible signal propagation paths being blocked, they would be able to communicate with one another successfully. So, the repeater is usually positioned between the devices and is closer to each device than the devices themselves are to each other. In particular, it is therefore likely that the device to which the repeater re-transmits the signal is only a very short distance away. For example, when the repeater is housed in a headset and the second device to which the signal is re-transmitted is in a user's back pocket or hand, the repeater and the second device are typically less than around 1 m apart. The repeater need not therefore re-transmit the signal very far. More specifically, it is preferred that the repeater transmits the signal over a range shorter than the maximum range of typical communication devices intended to operate in the communication system. Likewise, it is preferred that the method comprises transmitting the signal over a range shorter than the maximum range of typical communication devices intended to operate in the communication system. The very short range might be around 1 m or less.

Expressed differently, the repeater may only need to re-transmit the signal at very low power. More specifically, it is preferred that the repeater transmits the signal at power less than the power of typical communication devices intended to operate in the communication system. Similarly, it is preferred tat the method comprises transmitting the signal at power less than the power of typical communication devices intended to operate in the communication system. This might be less than 1 mW for example. This has the advantage that the re-transmitted signal is very unlikely to cause any interference with other transmissions in the radio communication system. Indeed, the very low power transmission can be well below regulatory thresholds for the second frequency band. This has a number of advantages. Firstly, the re-transmitted signal causes very little interference to other communication systems using the second frequency band. Secondly, there is no need for the re-transmitted signal to comply with any communication standard for transmissions in the second frequency band. The signal need not therefore be specifically coded and modulated for transmission in the second frequency band, which can significantly simplify the repeater as described in more detail below. Thirdly, the very low transmission power means that the repeater consumes very little power. It can therefore have long battery life or can be incorporated in another device (e.g. the headset) without significantly reducing that devices' battery life.

The second frequency band is usually substantially separate to, e.g. entirely distinct from, the first frequency band. As mentioned above, the first frequency band is typically the designated frequency band of a short range communication system, such as Bluetooth®, Wi-Fi® or such like. In other words, the first frequency band is preferably the designated frequency band of a short range wireless connectivity standard. In contrast, the second frequency band can be selected as desired, e.g. to suit particular requirements of a given short range communication system. Again, the low power of the re-transmitted signal means that substantially any frequency band can be selected as the second frequency band. However, it is preferred that the second frequency band is a designated Industrial, Scientific and Medical frequency (ISM) frequency band. This might be a band substantially at 400 MHz, 800 MHz, 2.45 GHz or 5.8 GHz for example. These bands are unregulated, which makes their use very straightforward and attractive. In terms of overcoming the attenuating effects of the human body it is preferred that the second frequency band be below 900 MHz.

It is particularly preferred that the second frequency band is at a lower frequency than the first frequency band. This reduces the likelihood of interference with the received signal (and e.g. other signals in the communication system), as low frequency signals are less likely to interfere with higher frequency signals. Furthermore, lower frequency signals are less likely to be attenuated by the human body. Re-transmitting the signal at a lower frequency therefore increases the likelihood of the re-transmitted signal reaching its destination, e.g. being received by the second communication device.

Re-transmission of the signal in the second frequency band can be achieved in a variety of ways. However, it is preferred that the repeater further comprises means for shifting the signal from the first frequency band to the second frequency band. In other words, it is preferred that the method further comprises shifting the signal from the first frequency band to the second frequency band. The shifting might involve demodulating (and optionally decoding) the received signal in the first frequency band and (optionally coding and) modulating and signal in the second frequency band as desired. In other words, totally independent communication links may be set up between the repeater and each communication device. However, it is preferred that just the frequency of the received signal is changed. No decoding or demodulating need therefore be carried out by the repeater. Rather, the signal may be directly re-transmilted (e.g. in an identical form to that with which it is received) but with an altered frequency (e.g. in the second frequency band). This means that the signal can be re-transmitted with negligible delay and the repeater can be kept simple and cheap.

The amount by which the frequency of the signal is changed may be selected dynamically. In other words, the frequency of the re-transmitted signal may be varied as desired, e.g. in accordance with any appropriate modulation scheme. In particular, the repeater may transmit the signal at a fixed frequency, e.g. 800 MHz, regardless of the frequency of the received signal. However, it is preferred that the frequency of the received signal is shifted by a constant frequency offset (which can alternatively be referred to as a frequency interval or shift). So, the re-transmitted signal always differs from the received signal by the constant frequency offset. This simplifies receipt of the re-transmitted signal by the second communication device, as the second communication device only needs to know the frequency of the signal transmitted by the first communication device and the value of the frequency offset to be able to successfully receive the re-transmitted signal. For example, if the first communication device is transmitting the signal using a channel defined by a frequency hopping scheme (as in Bluetooth®), the second communication device can continue to frequency hop in the same sequence and just apply the frequency offset to receive the re-transmitted signal. Changing the frequency of the received signal by a constant frequency offset also minimises the complexity of the repeater. The repeater need not set up dedicated communication links with other devices. Rather, the repeater can be entirely analogue.

In one example, the repeater may re-transmit all signals it receives (in the first frequency band). In other words, the repeater passes all signals it receives within the first frequency band for re-transmission. Again, this keeps the repeater simple and, as the signals may be re-transmitted at very low power, the problems of interference and power use that this may introduce can be ignored. However, in another example, the repeater may comprise a filter for filtering signals received in the first frequency band to remove signals and noise that may interfere with the signal received from the first communication device when transmitted by the repeater. In other words, the method may comprise filtering signals received in the first frequency band to remove signals and noise that may interfere with the signal received from the first communication device when transmitted by the repeater. For example, the repeater may filter the received signals to receive the signal from the first communication device in a channel in which the first communication device transmits the signal. So, in Bluetooth®, the repeater may frequency hop in the same sequence as the first communication device to receive the signal from the first communication device. The repeater still need not demodulate and decode the received signal, as the channel (e.g. frequency hopping sequence) can be identified without doing this. However, receiving the signal from the first communication device in the channel allows the repeater to filter the received signal very effectively and eliminate other interfering signals and noise before re-transmitting the signal.

So, it is preferred that the repeater comprises means for identifying the channel in which the first communication device is transmitting the signal and filtering the signals received in the first frequency band to receive the signal in the channel. In other words, it is preferred that the method comprises identifying the channel in which the first communication device is transmitting the signal and filtering the signals received in the first frequency band to receive the signal in the channel. This might be achieved by dedicated circuitry or processing means provided in the repeater. However, as mentioned above, the repeater may be incorporated in another communication device capable of communication in the communication system, such as headset for example. In this case, the means for identifying the channel may comprise means for interfacing with the other communications device to identify the channel in which the first communication device is transmitting the signal. Similarly, the channel identification may comprise interfacing with the other communications device to identify the channel in which the first communication device is transmitting the signal. The repeater is therefore kept simpler by using the link manager or such like of the other communication device in which it is incorporated to establish the channel (e.g. frequency hopping scheme) that the first communication device is using to transmit the signal.

The repeater may operate, e.g. receive and transmit, continually, e.g. whenever power is supplied to it. However, whilst this is simple, it is likely to lead to wasteful power use, as the repeater may well operate when no signals are being transmitted, e.g. by the first device. It is therefore preferred that the repeater only transmits when it receives a signal in the first frequency band above a given strength. The given strength might be around the same as the strength at which signals are typically received in the communication system.

The second communication device of the communication system might try to receive the signal in both the frequency bands at once. Indeed, the device could continually operate in this way. This would increase the likelihood of good reception of the signal but avoid the need for the second communication device to select between reception in the different frequency bands. This might make the second communication device simpler and cheaper. However, it is preferred that the second communication device can select between reception of the signal in the first frequency band or the second frequency band. In other words, the method preferably comprises selectively receiving the signal in the first frequency band or the second frequency band. So, for example, the communication device may receive the signal in the first frequency band by default. The device may then select to receive the signal in the second frequency band when it cannot adequately receive the signal in the first frequency band. For example, the device may select to receive the signal in the second frequency band when signal quality in the first frequency band is poor.

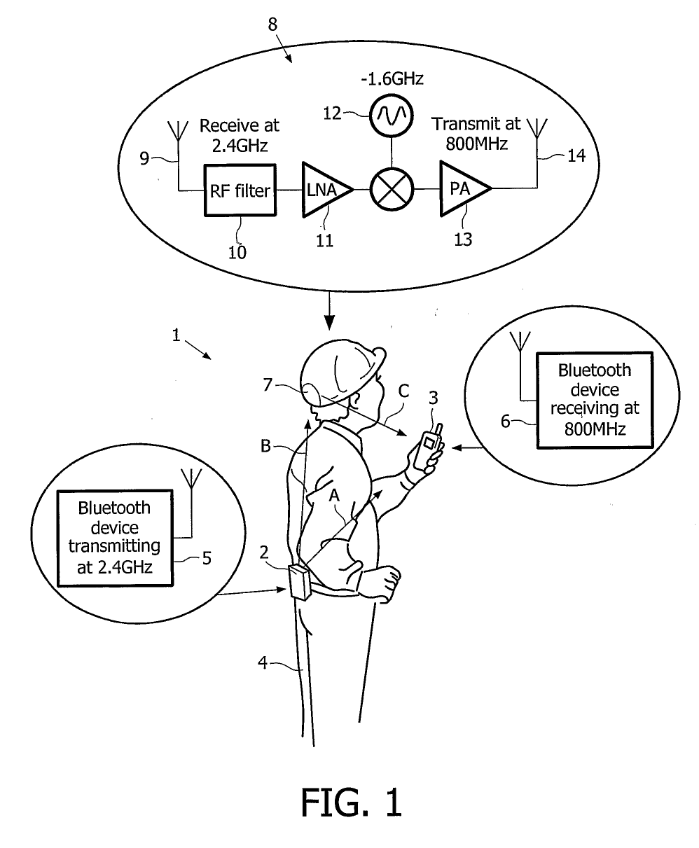

Preferred embodiments of the invention will now be described, by way of example only, with reference to the accompanying drawing, FIG. 1, which is a schematic illustration of a radio communication system including the repeater of the invention.

Referring to FIG. 1, a radio communication system 1 includes a mobile telephone 2 and a personal digital assistant (PDA) 3. The mobile telephone 2 is shown carried in a back trouser pocket of a user 4 and incorporates a Bluetooth® transceiver 5, shown in an exploded view. The PDA 3 is shown held in the hand of the user 4 and, like the mobile telephone 2, also incorporates a Bluetooth® transceiver 6, shown in an exploded view. So, in this embodiment, the radio communication system 1 is a Bluetooth® communication system. The transceivers 5, 6 are configured according to the latest version of the Bluetooth® specification, which is known as Core Specification v1.2, dated 5 Nov. 2003 and available from Bluetooth SIG, Inc. The invention is largely illustrated using just this embodiment, but it is applicable to a variety of other short range radio communication systems, including, in particular, Wi-Fi® systems. Some appropriate implementation details for communication systems other than Bluetooth® are mentioned below, but many others will be apparent to those skilled in the art.

The user 4 is wearing a headset 7 incorporating an earpiece and microphone (not shown) for voice communication. The headset 7 also houses a repeater 8 according to the invention, shown in an exploded view. The repeater 8 comprises a receive antenna 9 for receiving a signal. In this embodiment, the receive antenna 9 is adapted to receive signals best at around 2.4 GHz. The receive antenna 9 is connected to a radio frequency (RF) filter 10 for filtering received signals, which, in turn, is connected to a low noise amplifier 11 for amplifying the received signals. In this embodiment, the RF filter 10 is arranged to filter the received signals so that substantially only signals in the 2.4 GHz band are passed to the low noise amplifier 11. In other embodiments, the RF filter 10 is arranged to additionally filter the received signals so that a signal in received in (a) channel(s) (e.g. frequency hopping schemes) used by either one or both of the transceivers 5,6. This more effectively eliminates noise, but requires knowledge of the channels in use.

The repeater 8 has frequency shifting means 12 connected to receive the amplified signal from the low noise amplifier 11 and adapted to shift the signal to another frequency band. In this embodiment, the frequency shifting means 12 is a frequency reducing circuit adapted to convert the signal from the 2.4 GHz band to an 800 MHz band. In other words, the frequency shifting means 12 reduces the frequency of the received signal by 1.6 GHz. Finally, a power amplifier 13 for amplifying the frequency shifted signal is connected to the output of the frequency shifting means 12 and to a transmit antenna 14 for transmitting the frequency shifted signal. The transmit antenna 14 is adapted to transmit signals best at around 800 MHz.

So, in use, the mobile telephone 2 and the PDA 3 can communicate with each other using their Bluetooth® transceivers 5,6. For example, when the user 4 desires to browse the internet using the PDA 3, the user can cause the PDA 3 to establish a communications link with the mobile telephone 2, which, in turn, can connect to the internet using a mobile telephone network (not shown). In Bluetooth®, communication channels comprise defined frequency hopping schemes in the 2.4 GHz frequency band. To establish a communication link, the PDA 3 and mobile telephone 4 select one or more channels for communication and synchronise their internal clocks. Data packets can then be sent in the communications link at the appropriate time and frequency. This is described in more detail in the Bluetooth® specification mentioned above.

In order to maintain communication, it must be possible for the radio signals transmitted by the respective transceivers 5,6 of the PDA 3 and the mobile phone 4 to be received at sufficient signal strength by the other transceiver 5,6. The transceivers 5,6 typically have a range of around 10 metres over a line of sight (LOS) path. In other words, provided there are no obstacles directly between the transceivers 5,6, they should each receive the signal transmitted by the other transceiver 5,6 at sufficient signal strength if they are 10 m or less apart. However, if the LOS path is obstructed, they may only be able to receive the signal via a reflected path. Reflected paths between two devices are generally longer than the LOS path and weakened by the reflection. So, when the LOS path is blocked, the maximum range between the transceivers 5,6 at which they are still able to successfully communicate may be reduced, e.g. to less than 10 metres.

In this illustration, the mobile telephone 2 is in the user's back trouser pocket and the PDA 3 is held in a user's hand. The LOS path (illustrated by arrow A in FIG. 1) between the mobile telephone 2 and the PDA 3 is therefore easily blocked by the user's body. Furthermore, a reflected path may not be available. For example, all possible reflected paths may be too long, e.g. when the user 4 is outside. Similarly, components of the telephone 2 and/or PDA 3, such as their housing(s), can couple with the antenna(s) of the telephone 2 and/or the PDA 3, causing it/them to become more directional than designed. This can reduce signal strength in the direction of any potential reflected path. Likewise, the user's body can de-tune the antenna(s) or couple with the antenna(e) causing it/them to become more directional, having the same result. It is therefore very likely that, even though there is only a short range between the telephone 2 and PDA 3, there will be no signal propagation path between them.

When this happens, the transceivers 5,6 stop receiving signals directly from one another and, ordinarily, the communication link will break. However, according to the invention, the repeater 8 is positioned on the user's head. More specifically, the repeater 8 is housed in the user's headset 7. So, the repeater 8 can receive signals from both the transceiver 5 of the telephone 2 and the transceiver 6 of the PDA 3. In FIG. 1, the path from the telephone 2 to the repeater 8 is illustrated buy arrow B and the path from the repeater 8 to the PDA 3 is illustrated by arrow C.

The repeater 8 receives the signals via antenna 9, which is tuned to the 2.4 GHz band. The received signals are then filtered by RF filter 10, which only passes signals in the 2.4 GHz band. In this embodiment, after filtering, the received signal is amplified by low noise amplifier 11. The frequency shifting means 12 then reduces the frequency of the received signals by 1.6 GHz. In other words, the signal is shifted from the 2.4 GHz band to the 800 MHz band. The signal is otherwise unaltered. In particular, the signal is not demodulated or decoded.

Once the frequency shifting has been carried out, the signal is amplified by power amplifier 13 and transmitted via transmit antenna 14, which is tuned to 800 MHz. The power amplifier 13 only amplifies the signal to a strength that, when the signal is transmitted via the transmit antenna 14, it has a range of around 1 m. Typically, the power of the transmitted signal is therefore less than 1 mW. This reduces the possibility of the transmitted signal interfering with other signals in the radio communication system 1.

In FIG. 1, the signal propagation path A from the transceiver 5 of mobile telephone 2 to the transceiver 6 of PDA 3 is blocked by the body of the user 4. However, the signal propagation path B from the transceiver 5 of the mobile telephone 2 to the repeater 8 housed in the headset 7 is not blocked. The repeater 8 therefore receives the signal from the transceiver 5 of the mobile telephone 2 intended for the transceiver 6 of the PDA 3 (in the 2.4 GHz band). This signal is converted to the 800 MHz band and transmitted by the repeater 8. In particular, the converted signal travels along signal propagation path C from the repeater 8 to the transceiver 6 of the PDA 3.

At the same time, the signal propagation path from the transceiver 6 of PDA 3 to the transceiver 4 of mobile telephone 2 (in the opposite direction to that illustrated by arrow A in FIG. 1) is also blocked by the body of the user 4. However, the signal transmitted by the transceiver 6 of the PDA 3 intended for the transceiver 5 of the mobile telephone 2 can travel along a signal propagation path from the transceiver 6 of the PDA 3 to the repeater 8 (in the opposite direction of that illustrated by arrow C in FIG. 1). The repeater 8 therefore also receives this signal and converts and transmits it along with the signal from the transceiver 5 of the mobile telephone 2. The repeater 8 does not need to decode or separate these signals in any way. Rather, the coded and modulated signals are simply converted together, effectively as one signal, by the repeater 8. When the signals are retransmitted in the 800 MHz band, they are therefore still coded and synchronised as they were in the 2.4 GHz band. In other words the signals are simply transposed to equivalent channels in the 800 MHz band.

The transceivers 5,6 receive the signals in the 800 MHz band. In this example, the transceivers each convert the signals back to the 2.4 GHz band and decode and demodulate the signals as normal. Conventional synchronisation methods can be used to compensate for the small delay induced by the repeater 8. Whenever the transceivers 5,6 are communicating with one another, they continually try to receive signals in both the 2.4 GHz band and the 800 MHz band. Should the signals in the 2.4 GHz band become blocked, the signals are still therefore received in the 800 MHz band. In other embodiments, the transceivers 5,6 selectively switch to receive the signals in the 800 MHz band when signal quality in the 2.4 GHz band deteriorates or becomes poor.

In this embodiment, the repeater 8 operates continually. In other words, provided the repeater 8 is in place and switched on, the signals are always received, converted and re-transmitted. This helps to keep the transceiver as simple as possible. Of course, in other embodiments, the repeater may be switched on and off from time to time, e.g. remotely from one of the transceivers 5,6 when signal quality in the 2.4 GHz band deteriorates. In another embodiment, the repeater 8 only transmits a signal when it receives a signal with strength greater than that at which signals are typically received in the communication system 1.

The described embodiments of the invention are only examples of how the invention may be implemented. Modifications, variations and changes to the described embodiments will occur to those having appropriate skills and knowledge. These modifications, variations and changes may be made without departure from the spirit and scope of the invention defined in the claims and its equivalents.

1. A radio repeater (8) for use in a short range radio communication system (1), the repeater (8) comprising a receiver for receiving a signal in a first frequency band and a transmitter for transmitting the signal in a second frequency band.

2. The radio repeater (8) of claim 1, wherein the transmitter transmits the signal over a maximum range shorter than the maximum range of typical communication devices (5,6) intended to operate in the radio communication system (1).

3. The radio repeater (8) of claim 1, wherein the transmitter transmits the signal over a maximum range of around 1 m or less.

4. The radio repeater (8) of claim 1, wherein the transmitter transmits the signal at power less than the power of typical communication devices (5,6) intended to operate in the radio communication system (1).

5. The radio repeater (8) of claim 1, wherein the first frequency band is the designated band of a short range wireless connectivity standard.

6. The radio repeater (8) of claim 1, wherein the second frequency band is at a lower frequency than the first frequency band.

7. The radio repeater (8) of claim 1, further comprising a means (12) for shifting the signal from the first frequency band to the second frequency band.

8. The radio repeater (8) of claim 7, wherein the signal is shifted by a constant frequency offset.

9. The radio repeater (8) of claim 1, comprising a filter (10) for filtering signals received in the first frequency band to remove signals and noise that may interfere with a signal received from a first communication device (5,6) when transmitted by the repeater (8).

10. The radio repeater (8) of claim 1, comprising means for identifying the channel in which a/the first communication device (5,6) is transmitting the signal and filtering (the) signals received in the first frequency band to receive the signal in the channel.

11. The radio repeater (8) of claim 1, wherein the repeater (8) only transmits when it receives a signal in the first frequency band above a given signal strength.

12. The radio repeater (8) of claim 1 capable of being worn on or attached to the body or clothing of a user (4).

13. A short range radio communication (1) system comprising:
a first communication device (5,6) for transmitting the signal in the first frequency band;
the repeater (8) of claim 1; and
a second communication device (5,6) for receiving the signal in the first frequency band or the second frequency band.

14. The short range radio communication (1) system of claim 13, wherein the second communication device (5,6) selects to receive the signal in the second frequency band when the quality of the signal in the first frequency band is poor.

15. A method of repeating a signal in a short range radio communication system (1), the method comprising receiving a signal in a first frequency band and transmitting the signal in a second frequency band.

16. The method of claim 15, comprising transmitting the signal over a maximum range shorter than the maximum range of typical communication devices (5,6) intended to operate in the radio communication system (1).

17. The method claim 15, comprising transmitting the signal over a maximum range of around 1 m or less.

18. The method of claim 15, comprising transmitting the signal at power less than the power of typical communication devices (5,6) intended to operate in the radio communication system (1).

19. The method of claim 15, wherein the first frequency band is the designated band of a short range wireless connectivity standard.

20. The method of claim 15, wherein the second frequency band is at a lower frequency than the first frequency band.

21. The method of claim 15, comprising shifting the signal from the first frequency band to the second frequency band.

22. The method of claim 21, comprising shifting the signal by a constant frequency offset.

23. The method of claim 15, comprising filtering signals received in the first frequency band to remove signals and noise that may interfere with a signal received from a first communication device when transmitted by the repeater.

24. The method of claim 15, comprising identifying the channel in which a/the first communication device (5,6) is transmitting the signal and filtering (the) signals received in the first frequency band to receive the signal in the channel.

25. The method of claim 15, comprising only transmitting a signal when a signal is received in the first frequency band above a given signal strength.

26. A method of short range radio communication comprising:
transmitting the signal in the first frequency band;
repeating the radio signal using the method of claim 15; and
receiving the signal in the first frequency band or the second frequency band.

27. The method of claim 26, comprising selecting to receiving the signal in the second frequency band when the quality of the signal in the first frequency band is poor.
